(19) United States
(12) Patent Application Publication
(10) Pub. No.: US 2004/0239564 A1
(43) Pub. Date: Dec. 2, 2004

(54) Antenna and electronic apparatus using it

(76) Inventors: Misako Sakae, Osaka (JP); Naoki Yuda, Osaka (JP); Hiroshi Takahashi, Osaka (JP); Shinji Harada, Osaka (JP); Tsutomu Inuzuka, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/475,498

(22) PCT Filed: Mar. 26, 2003
(86) PCT No.: PCT/JP03/03693

(30) Foreign Application Priority Data
Mar. 28, 2002 (JP) 2002-92125

(51) Int. Cl. H01Q 1/38

(52) U.S. Cl. 343/700 MS

(57) ABSTRACT

An antenna of the present invention is provided with a magnetic material (31) in the vicinity of a grounding lead wire (28) and with a nonmagnetic space between a radiation electrode (27) and a ground electrode (26).

### TECHNICAL FIELD

The present invention relates to an antenna and an electronic apparatus using the same.

### BACKGROUND ART

The conventional antenna of such type includes a plate-type ground electrode, a plate-type radiation electrode disposed opposite to the ground electrode with a predetermined space therebetween, a grounding lead wire for connecting the radiation electrode to the ground electrode, and a power supplying lead wire connected to the radiation electrode. The described configuration having the ground electrode connected to the radiation electrode by the grounding lead wire produces a λ/4 mode resonance and, thereby, a radio wave due to a resonance current is radiated. The λ/4 mode is such a resonance mode establishing a maximum current at the grounding lead wire and establishing a minimum current, and a maximum voltage, at the open end farthest from the grounding lead wire.

In the conventional antenna as noted above, in order to reduce the antenna size, such an attempt has been made to insert a dielectric material or a magnetic material between the ground electrode and the radiation electrode. From this, it is expected that the wavelength of the electromagnetic field between the ground electrode and the radiation electrode can be shortened and hence the size of the antenna can be reduced.

A λ/4 resonance can be equivalently represented by a parallel-resonant circuit in which an inductor and a capacitor are connected in parallel. When the wavelength of such a λ/4 resonator is shortened with use of a dielectric, the value of the capacitor (hereinafter referred to as capacitance) equivalently increases so that the frequency characteristic of impedance becomes steep and the bandwidth is narrowed. When, on the other hand, a magnetic material is used, the value of the inductor (hereinafter referred to as inductance) equivalently increases so that the frequency characteristic of impedance becomes gentle and the bandwidth can be broadened. Therefore, use of a magnetic material is effective for obtaining a broadband antenna. Generally, however, a magnetic material has also a characteristic as a dielectric material. In terms of antenna loss, while there is incurred only a dielectric loss when a dielectric is used, both a magnetic loss and a dielectric loss are incurred when a magnetic material is used. Thus, in the use of a magnetic material, there has been a problem of deterioration in the radiation efficiency.

### DISCLOSURE OF THE INVENTION

An antenna is provided, which comprises a ground electrode substantially in a plate type, a radiation electrode substantially in a plate type disposed opposite to the ground electrode with a predetermined space therebetween, a grounding lead wire for connecting the radiation electrode to the ground electrode, and a power supplying lead wire connected to the radiation electrode, and which further has a magnetic material disposed in the vicinity of the grounding lead wire and a space of a nonmagnetic material between the radiation electrode and the ground electrode.

### BRIEF DESCRIPTION OF THE DRAWINGS

FIG. 1 is an exploded view in perspective showing an embodiment of the present invention.

FIG. 2 is an exploded view in perspective of an antenna portion showing the embodiment of the present invention.

FIG. 3 is an electric circuit diagram showing the embodiment of the present invention.

### DETAILED DESCRIPTION OF PREFERRED EMBODIMENTS

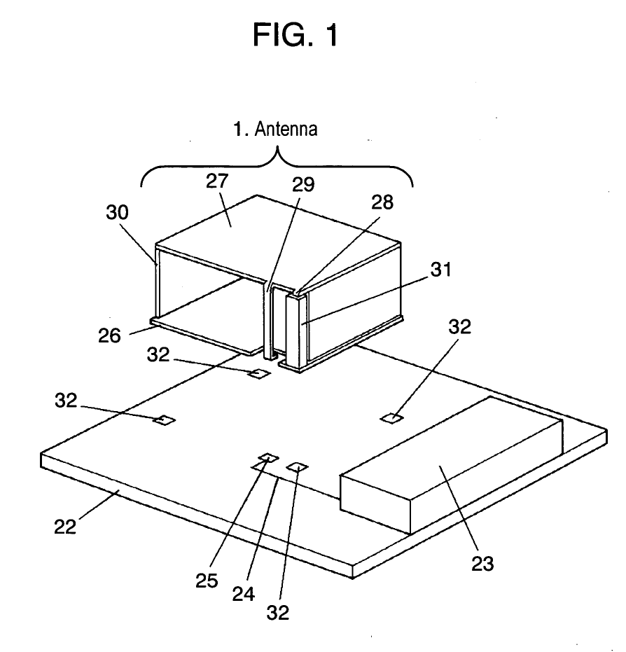

A preferred embodiment of the present invention will be described with reference to FIG. 1 to FIG. 3.

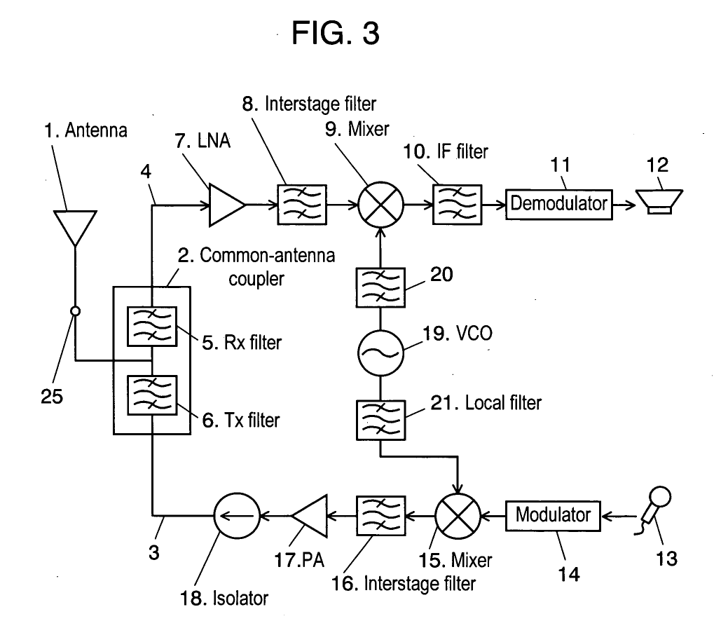

FIG. 1 to FIG. 3 show the preferred embodiment and there is shown a mobile telephone as an example of electronic apparatuses. Namely, FIG. 3 shows an electric circuit of the mobile telephone. As shown in FIG. 3, antenna 1 is connected with transmission line 3 and reception line 4 through common-antenna coupler 2. Common-antenna coupler 2 includes transmission filter 5 and reception filter 6. A radio wave received from antenna 1 is transmitted to reception line 4 through common-antenna coupler 2, while a transmitted signal such as an audio signal is transmitted from antenna 1 by way of transmission line 3 and common-antenna coupler 2. While detailed description is omitted, the electric circuit shown in FIG. 3 shows a general example of a mobile telephone and, therein, reception line 4 is connected to speaker 12 by way of amplifier 7, inter-stage filter 8, mixer 9, IF filter 10, and demodulator 11. On the other hand, transmission line 3 is provided first with microphone 13 and then with modulator 14, mixer 15, inter-stage filter 16, amplifier 17, and isolator 18, to be finally connected to common-antenna coupler 2. Further, mixers 9 and 15 are connected with voltage-controlled oscillator (VCO) 19 through filters 20 and 21, respectively.

An arrangement having the above mentioned circuit diagram concretely embodied is shown in FIG. 1.

Referring to FIG. 1, components of transmission line 3, as well as components of reception line 4, from common-antenna coupler 2 shown in FIG. 3 to demodulator 11 or to modulator 14 are arranged as transmission-reception circuit portion 23 on printed circuit board 22 in FIG. 1. Signal line 24 is lead out from circuit portion 23 and this signal line 24 is connected to power supplying terminal 25. Power supplying terminal 25 is disposed between antenna 1 and common-antenna coupler 2 in FIG. 3.

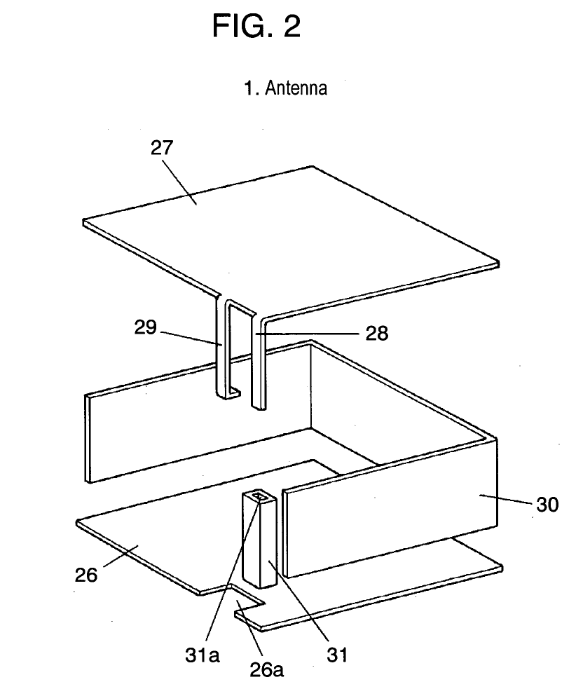

Other than transmission-reception circuit portion 23, there is provided antenna 1 in FIG. 1. Antenna 1 is constituted of components as shown in FIG. 2. Namely, it is constituted of a ground electrode 26 formed for example of a copper plate, radiation electrode 27 equally formed of a copper plate and disposed above ground electrode 26 with a predetermined space therebetween, grounding lead wire 28 projected from radiation electrode 27, power supplying lead wire 29, and magnetic material 31.

Grounding lead wire 28, as shown in FIG. 2, is outwardly extended from a corner portion of radiation electrode 27 in a plate type and then bent down. The bent portion is inserted into through hole 31a in magnetic material 31 in a square rod shape as shown in FIG. 1 to be electrically and mechanically connected at its bottom end with ground electrode 26. Further, power supplying lead wire 29 equally outwardly extended from radiation electrode 27 in a plate type from its outer circumferential portion and then bent down is adapted to be electrically and mechanically connected with power supplying terminal 25 shown in FIG. 1 through a cut portion 26a provided in ground electrode 26 shown in FIG. 2.

Spacer 30 has a U-shaped cross-section as shown in FIG. 2 and is arranged to hold the outer circumferential portion of radiation electrode 27 above ground electrode 26. Spacer 30 is made for example of an insulator such as ABS resin. Further, magnetic material 31 is made of a ferrite type material. Ground electrode 26 is adapted to be electrically and mechanically connected with printed circuit board 22 at four grounding terminals 32 as shown in FIG. 1.

In the configuration shown above, radiation electrode 27 basically serves as an antenna. By having radiation electrode 27 connected with ground electrode 26 by way of grounding lead wire 28, it functions as an antenna of a λ/4 resonance mode.

Under described conditions, the point most characteristic of the present embodiment is that grounding lead wire 28 is arranged to pass through magnetic material 31 in a square rod shape. By this arrangement, such a state can be created in which magnetic material 31 is present around grounding lead wire 28 where the most extensive concentration of currents takes place in a λ/4 resonance mode. Since a magnetic field is generated to turn around a direction of a current flow, magnetic material 31 provided around the periphery of grounding lead wire 28 acts most effectively on the magnetic field. Thereby, while the wave-length shortening effect is exhibited, the inductance is increased and the frequency characteristic of the impedance can be made gentle. As a result, antenna 1 shown in FIG. 2 is usable for a broadband while small in size. To be concrete, radiation electrode 27 and ground electrode 26 can be made smaller. Therefore, the electronic apparatus using the mobile telephone shown in FIG. 3 as an example can be made smaller in size.

Spacer 30 shown in FIG. 2 is provided at the outer circumferential portion of radiation electrode 27 and spacer 30 is made of an insulating material as described above. Inherently, if the space between radiation electrode 27 and ground electrode 26 were all provided by a magnetic material, miniaturization and a broadband application of antenna 1 would be achieved. Then, however, such a disadvantage occurs that the radiation efficiency is deteriorated due to dielectric loss and magnetic loss characteristic of the magnetic material. Therefore, in the above described embodiment, to obtain high effectiveness, magnetic material 31 is limitedly disposed around grounding lead wire 28 where electric power concentrates. On the contrary, the other portions where concentration of electric current is weak is arranged to be devoid of magnetic material 31 and left to be only mechanically supported by spacer 30. Further, as the material of spacer 30, an insulator substantially free of dielectric loss and magnetic loss is used and, thereby, occurrence of dielectric loss and magnetic loss is prevented. By virtue of the above described configuration, while miniaturization and applicability to a broadband of antenna 1 are attained, its deterioration in radiation efficiency is prevented. Further, by suppressing variations in distance between radiation electrode 27 and ground electrode 26, an antenna with a stabilized characteristic can be provided.

Although magnetic material 31 has been disposed only in the vicinity of grounding lead wire 28 in the above described embodiment, the magnetic material 31 may, in addition, be disposed at another portion. Especially, depending on the shape of the antenna, such a case can be considered that a current concentration also occurs at the circumference of radiation electrode 27 due to an edge effect. In such a case, a magnetic material may be disposed at the circumference of radiation electrode 27, or at a part thereof, in addition to the vicinity of grounding lead wire 28.

The present invention, as described above, comprises a ground electrode substantially in a plate type, a radiation electrode substantially in a plate type and disposed opposite to the ground electrode with a predetermined space therebetween, a grounding lead wire for connecting the ground electrode with the radiation electrode, and a power supplying lead wire connected with a power supplying electrode, and in which, it has a magnetic material disposed in the vicinity of the grounding lead wire and a non-magnetic space provided between the radiation electrode and the ground electrode. Accordingly, it is made possible to provide an antenna small in size and applicable to a broadband and is free from deterioration in the radiation efficiency and, also, to provide a small-sized electronic apparatus.

### INDUSTRIAL APPLICABILITY

The present invention relates to an antenna and an electronic apparatus using the same and has an object to provide such that attains miniaturization and applicability to a broadband and is capable of suppressing loss and preventing deterioration of radiation efficiency.

1. An antenna comprising:
a ground electrode substantially in a plate type;
a radiation electrode in a substantially plate type disposed opposite to said ground electrode with a predetermined space therebetween;
a grounding lead wire for connecting said radiation electrode with said ground electrode; and
a power supplying lead wire connected to said radiation electrode; wherein said antenna has:
a magnetic material in the vicinity of said grounding lead wire; and
a nonmagnetic space between said radiation electrode and said ground electrode.

2. The antenna according to claim 1, wherein said magnetic material is a rod-shaped magnetic material.

3. The antenna according to claim 1, wherein said grounding lead wire is passed through a through hole portion in said magnetic material.

4. The antenna according to claim 1, wherein said grounding lead wire is outwardly extended from a circumferential portion of said radiation electrode.

5. The antenna according to claim 1 to 4, wherein said magnetic material is provided at a circumferential portion of said radiation electrode.

6. The antenna according to claim 5, wherein a spacer is provided between the circumferential portion of said radiation electrode, except the portion from which said grounding lead wire is outwardly extended, and said ground electrode.

7. The antenna according to claim 6, wherein said spacer is made of an insulating material.

8. An electronic apparatus having said power supplying lead wire of said antenna according to claim 1 connected to at least one of a transmission line and reception line.

9. The antenna according to claim 2, wherein said grounding lead wire is outwardly extended from a circumferential portion of said radiation electrode.

10. The antenna according to claim 3, wherein said grounding lead wire is outwardly extended from a circumferential portion of said radiation electrode.

11. The antenna according to claim 2, wherein said magnetic material is provided at a circumferential portion of said radiation electrode.

12. The antenna according to claim 3, wherein said magnetic material is provided at a circumferential portion of said radiation electrode.

13. The antenna according to claim 4, wherein said magnetic material is provided at a circumferential portion of said radiation electrode.

14. An electronic apparatus having said power supplying lead wire of said antenna according to claim 2 connected to at least one of a transmission line and reception line.

15. An electronic apparatus having said power supplying lead wire of said antenna according to claim 3 connected to at least one of a transmission line and reception line.

16. An electronic apparatus having said power supplying lead wire of said antenna according to claim 4 connected to at least one of a transmission line and reception line.

17. An electronic apparatus having said power supplying lead wire of said antenna according to claim 5 connected to at least one of a transmission line and reception line.

18. An electronic apparatus having said power supplying lead wire of said antenna according to claim 6 connected to at least one of a transmission line and reception line.

19. An electronic apparatus having said power supplying lead wire of said antenna according to claim 7 connected to at least one of a transmission line and reception line.
